(19) United States
(12) Patent Application Publication
(10) Pub. No.: US 2002/0133802 A1
(43) Pub. Date: Sep. 19, 2002

(54) Method and system for building and displaying computer generated models

(76) Inventors: Daryl C. Spradlin, Mebane, NC (US); Elwood Combs, Mebane, NC (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 09/681,333

(22) Filed: Mar. 19, 2001

Related U.S. Application Data
(60) Provisional application No. 60/253,388, filed on Nov. 28, 2000.

(51) Int. Cl. G06F 9/44

(52) U.S. Cl. 717/104

(57) ABSTRACT

A method and system for building an as-needed computer generated model, including the step of storing a max-case model file relating to a max-case design model, wherein said max-case design model including a plurality of model sub-components. Viewer-readable files are extracted and stored for each of said plurality of model sub-components. A max-case design script is generated including retrieval information for each of said plurality of model sub-components. In response to user selection of particular as-needed model sub-components, an as-needed design script is generated including retrieval information for each of the as-needed model sub-components. The viewer-readable files for each of the as-needed model sub-components are retrieved by a model viewing application. The model viewing application then builds and displays the as-needed model from the retrieved viewer-readable files.

### CROSS REFERENCE TO RELATED APPLICATIONS

This application claims the benefit of provisional patent application Serial No. 60/253,388, filed Nov. 28, 2000, the disclosure of which is incorporated herein by reference.

### BACKGROUND OF INVENTION

The present invention relates generally to computer-generated modeling systems. More particularly, the present invention relates to methods and systems for building viewable computer-generated models based upon a larger model file.

In designing and manufacturing products, it is known to utilize two or three-dimensional modeling software to both create and test designs prior to actually building them. This process has drastically reduced the amount of time it takes to bring a product from “the drawing board” to the marketplace. In certain circumstances, product designers will design a product including a plurality of possible sub-component combinations and orientations. The product design which reflects all of these possible combinations/orientation may be referred to as the max-case or maximum case design and may include thousands of possible product combinations/orientations all stored within a single max-case file.

Once a particular design choice has been selected, conventional practice requires the retrieval of the entire max-case model viewer file, including all of the unwanted sub-components and/or product orientations. Because most max-case model viewer files are substantial in size, they require large amounts of processing power and memory resources to retrieve and open into a local model viewing application. Consequently, the time taken to open the selected design model is substantial. Further, in conventional practice, all manipulation of the design must be made in the modeling software, thus adding to the size and complexity of the max-case design.

Therefore, there is a need in the art of computer-generated modeling for a method and system for selectively configuring and retrieving model viewer files which do not include unwanted sub-components or orientations. There is a further need for a method and system which enables users to manipulate model sub-components outside of the modeling software.

### SUMMARY OF INVENTION

The present invention overcomes the problems noted above, and provides additional advantages, by providing a method and system for building an as-needed computer generated model, including the step of storing a max-case model file relating to a max-case design model, wherein said max-case design model including a plurality of model sub-components. Viewer-readable files are extracted and stored for each of said plurality of model sub-components and include a label for enabling subsequent identifier and parsing of the sub-components. A max-case design script is generated including retrieval information for each of said plurality of model sub-components. In response to user selection of particular as-needed model sub-components, an as-needed design script is generated including retrieval information for each of the as-needed model sub-components. The viewer-readable files for each of the as-needed model sub-components are retrieved by a model viewing application. The model viewing application then builds and displays the as-needed model from the retrieved viewer-readable files.

By enabling users to configure designs to include only as-needed model sub-components, viewer scripts are generated which include reference only to those sub-components, rather than the conventional max-case design script which includes all available sub-components. The model viewing application then, using the as-needed script, retrieve only the as-needed model sub-components, thus resulting in significant improvements in performance and speed.

### BRIEF DESCRIPTION OF DRAWINGS

The present invention can be understood more completely by reading the following Detailed Description of exemplary embodiments, in conjunction with the accompanying drawings, in which:

FIG. 1 is a generalized block diagram illustrating one embodiment of a computer system for implementing the present invention;

FIG. 2 is a flow chart describing a first embodiment of a method for building and viewing a model having selected sub-component elements; and

FIG. 3 is a flow chart describing a second embodiment of a method for building and viewing a model having selected sub-component elements.

### DETAILED DESCRIPTION

The system and method of the present invention described below, are preferably implemented by a computer software system incorporated within a computer-readable medium such as a hard disk drive, an optical medium such as a compact disk, or the like. The computer software system may also be located either locally on a user's computer or remotely over a computer network, such as a local area network (LAN) or the Internet. In general, the computer software system is designed to extract information about previously created computer-generated models made up of various sub-components and stored in a remote location. The system then enables users to define a particular model using only particular selected sub-components. The system operates to retrieve the selected sub-components from a remote location, builds them in the proper orientation and displays them to the user. In this manner, the time taken to build and display a particular model on a user's local computer is significantly reduced. In a preferred embodiment, the computer software system includes at least one application written in the C++ programming language, although any suitable programming language and interface are within the scope of the present invention.

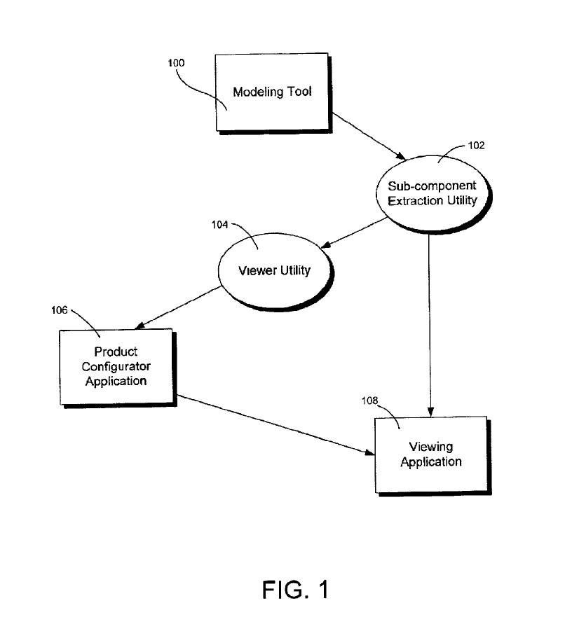

Referring now to the Figures and specifically to FIG. 1, there is shown a generalized block diagram illustrating one embodiment of a computer system for implementing the present invention. It should be understood that each of the various elements disclosed in FIG. 1, comprise software or hardware-based applications, either located or remotely located, which together form the system of the present invention. Initially, a conventional two or three dimensional modeling tool 100 is used to create at least one computer-generated product model including all of the various sub-components which may be included with any of the plurality of possible product combinations. One example of a suitable multidimensional modeling tool is the Pro/ENGINEER (Pro/E) suite of products by PTC Corporation of Needham, Mass., although any suitable modeling tool may be utilized in the present invention. Once the product model has been created in the modeling tool, the model and its sub-components are saved in a computer-readable medium for subsequent retrieval and modification.

Because the saved product model file includes information and sub-components for each possible combination of a finished product, many of the sub-components included will not be utilized in particular product design combinations. Further, the relative orientation of particular sub-component parts may be modified depending on the product configuration being manufactured.

Models meeting all possible configurations and combinations may be referred to as max-case models, referring to the maximum number of product cases.

Conventionally, model viewing software applications are required to save and open the complete max-case model file even when a desired configuration requires the display of less than all of the possible sub-components. This process of saving and opening the max-case model file is extremely taxing on typical manufacturing facility workstations. By eliminating the need to save and open the entire max-case model file, the present invention substantially decreases the processing time and memory requirements necessary to view particular combinations of the model.

A sub-component extraction utility 102 operates to extract each max-case model sub-component and save it in a file viewing format such as VRML (a 3-D rotatable format), TIFF (tagged image file format), or any suitable file viewing format. This utility is generally included with conventional model viewing software applications and enables individual viewing of the various model sub-components. Once all model sub-components have been extracted, a viewer utility 104 generates an executable max-case design script file, which includes the names for all of the various model sub-components and enables the viewing application to build and display the max-case model. Further, the max-case design script also includes orientation, location and identification information for each of the sub-components, indicating their location and spatial orientation with respect to the entire assembly. In a preferred embodiment, the script file is written in the ASCII format and includes orientation information relating to as many as six degrees of freedom for each model sub-component. Please note that the ASCII format is referenced for exemplary purposes only and any suitable script file format may be implemented in accordance with the present invention.

A product configurator software application 106 receives the max-case design script file and provides an interface which enables users to select particular combinations and orientations of model sub-components to join together in a particular as-needed product configuration. Upon user selection of a particular combination and orientation of model sub-components, the product configurator 106 saves the selected combination of sub-components for subsequent forwarding to the model viewing application 108. Once the selected combination is forwarded, the viewing application 108 then generates an as-needed design script based upon the max-case script generated by viewer utility 104 which includes and identifies only those sub-components selected by the user. Once an appropriate as-needed script is generated, the viewing application executes the script and calls the various sub-components included therein from the saved sub-component files extracted by the extraction utility 102. The viewing application then builds and displays the specific as-needed model to the user for view and printing.

In a preferred embodiment, the product configurator 106 is a computer software application written in the C++ language, although any suitable computer programming language may be used. Further, in one embodiment, the max-case model and sub-component data are stored in at least one database. Preferably, a SQL (Structured Query Language) server provides access to the database from client workstations at remote locations. In this embodiment, the product configurator 106 operates to query the database in response to user selection of particular sub-components and orientations.

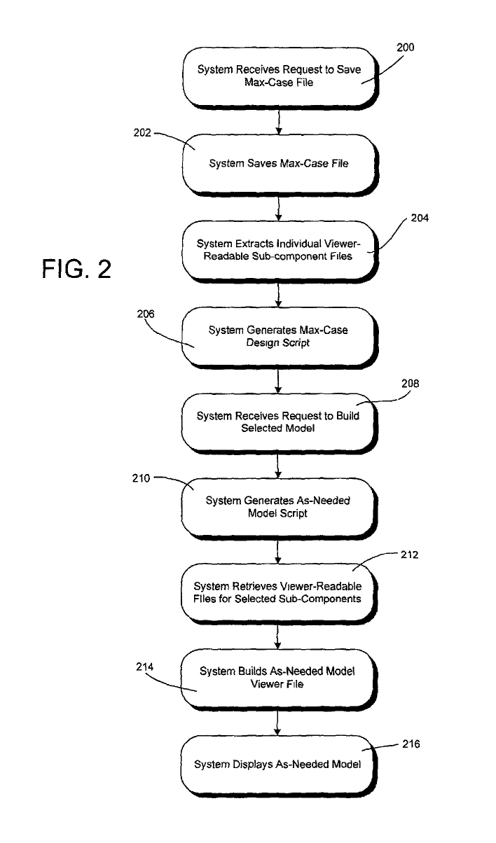

Referring now to FIG. 2, there is shown a flow chart describing one embodiment of a method for building and viewing a model having selected sub-component elements. In step 200, a computer system implementing the present invention receives a request to save a max-case model file from a modeling tool such as Pro/E. Next, in step 202, the system saves the file in a computer-readable medium for subsequent retrieval, modification, and display. In step 204, the system extracts individual, viewer-readable files for each model sub-component included in the max-case model and stores them for future retrieval by the view application.

Once the sub-component view files have been created, the system, in step 206, generates a max-case design script file which includes at least retrieval information for all of the various model sub-components. The retrieval information may simply include a listing of sub-components and the location of the corresponding viewer-readable sub-component files. Additionally, the max-case design script file also includes relative location, orientation, and identification information relating to each sub-component, thus permitting retrieval and subsequent regeneration of the complete max-case design model.

Following generation of the max-case design script file, the system, in step 208, receives a request from a user to build a model having selected sub-components. Each of steps 200-206 generally occur upon the initial creation or subsequent modification of new max-case design models by a product design group. The product configurator is then used in step 208 to define equipment needed to meet a particular customer need or specification, within the scope of the max-case designs provided by the product design group. After a particular job's needs are established, an as-needed model may be requested. In response, the system, in step 210, generates an as-needed model script file including the listing and location information for each of the selected sub-components. In step 212, the system retrieves the viewer-readable files extracted and stored in step 204 associated only with the particularly selected sub-components. In step 214 the system builds the as-needed model viewer file from the retrieved viewer-readable files and, in step 216, displays the as-needed model to the user.

By facilitating the generation of specific as-needed model script files, the system of the present invention eliminates the need to retrieve the entire max-case model when only a selected combination of sub-components is to be viewed. Because of the decreased need for processing power and local memory resources, performance in the viewing of such as-needed models is substantially increased.

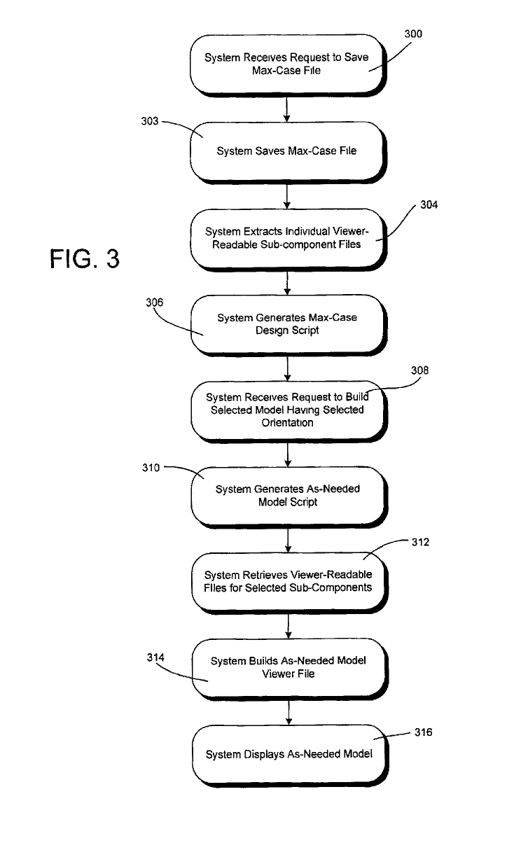

Referring now to FIG. 3, there is shown a flow chart describing a second embodiment of a method for building and viewing a model having selected sub-component elements. In contrast to the embodiment described above in FIG. 2, the embodiment of FIG. 3, enables users to not only retrieve and view selected sub-components of a max-case model but also manipulate the spatial orientation of each sub-component in the as-needed model.

In step 300, the system receives a request to save the max-case model file from Pro/E. Next, in step 302, as above, the system saves the file in a computer-readable medium for subsequent retrieval, modification, and display. In step 304, the system extracts individual, viewer-readable files for each model sub-component included in the max-case model and stores them for future retrieval by the view application.

Once the sub-component view files have been created, the system, in step 306, generates a max-case design script file which includes at least a listing of the file names for all of the various model sub-components. Contrary to the method described above however, the max-case design script includes specific coordinate location information for each of the sub-components in the max-case. As many as six specific coordinates are contemplated, including: rotation about the x, y, and z axes, relative to pre-established coordinate axes, and offsets in the x, y, and z directions relative to a predetermined model center point. The above location and orientation information is offered for exemplary purposes only and it should be understood that any suitable type and number of coordinates or other indicia may be utilized to specifically describe the orientation of each saved model sub-component. In particular, the format and number of coordinates required to locate and position a sub-component are typically dependent on the particular viewing application utilized and any suitable combination is within the scope of the present invention.

Following generation of the max-case design script file, the system, in step 308, receives a request from a user to build a model having selected ones of the sub-components. Further, this request may include positioning or re-locating sub-components in manners not discretely included within the max-case model. For example, a max-case model may include unit A inserted into an assembly at a location of 12 inches off of the assembly's base. In accordance with this embodiment of the present invention, the user may specify the insertion of unit A in various locations and orientations other than 12 inches off of the assembly's base. In this manner, file sizes of max-case models including many possible locations and/or orientations of identical sub-components may be significantly reduced.

Once sub-component selection and orientation has been received, the system, in step 310, generates an as-needed model script file including the listing and location information for each of the selected sub-components. In step 312, the system retrieves the viewer-readable files extracted and stored in step 304 associated only with the particularly selected sub-components. In step 314 the system builds the as-needed model viewer file from the retrieved viewer-readable files including manipulating the sub-components in any manner identified in step 308. In step 316, the system then displays the as-needed model to the user.

By providing the ability to reposition individual model sub-components outside of the max-case design file, system performance is substantially improved. Likewise, memory resources are reduced by eliminating the need to save model files having each and every possible combination of sub-components. Rather, only single instances of each sub-component need to be saved within the max-case model file. Subsequent position may be handled through much smaller viewer script files and viewer files.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

1. A method for building an as-needed computer generated model, comprising the steps of:
storing a max-case model file relating to a max-case design model, wherein said max-case design model includes plurality of model sub-components;
extracting viewer-readable files for each of said plurality of model sub-components;
generating a max-case design script including retrieval information for each of said plurality of model sub-components;
receiving a user selection of particular as-needed model sub-components;
generating an as-needed design script including retrieval information for each of the as-needed model sub-components;
retrieving, in a model viewing application, the viewer-readable files for each of the as-needed model sub-components;
building the as-needed model from the retrieved viewer-readable files; and
displaying the as-needed model to the user.

2. The method of claim 1, wherein the step of generating a max-case design script further comprises the step of extracting location information for each of the model sub-components.

3. The method of claim 1, further comprising the step of storing said viewer-readable files in at least one computer-readable medium.

4. The method of claim 1, further comprising the step of storing said user selection of particular as-needed model sub-components in at least one computer-readable medium.

5. The method of claim 1, wherein at least the step of: extracting viewer-readable files for each of said plurality of model sub-components; receiving a user selection of particular as-needed model sub-components; and displaying the as-needed model to the user are completed at remote locations to each other.

6. The method of claim 5, wherein the remote locations are connected by a computer network.

7. The method of claim 1, further comprising the step of storing said viewer-readable files a VRML file format.

8. The method of claim 1, further comprising the step of storing said viewer-readable files in a TIFF file format.

9. The method of claim 1, further comprising the step of storing said max-case design script and said as-needed design script in an ASCII file format.

10. The method of claim 1, further comprising the steps of:
extracting spatial orientation information related to the three dimensional orientation of each of the model sub-components and including the spatial orientation information in the max-case design script;
receiving, from the user, sub-component placement and orientation information for each as-needed model sub-component; and
including within the as-needed design script, the received sub-component placement and orientation information.

11. The method of claim 10, wherein said spatial orientation information includes six degrees of freedom.

12. The method of claim 10, wherein said spatial orientation information includes coordinates for an angle of rotation about each of the x, y, and z axes, relative to a pre-established coordinate axes, and an offset in each of the x, y, and z directions relative to a predetermined model center point.

13. A method for building and displaying an as-needed computer generated model, comprising the steps of:
receiving a selection of a plurality of model sub-components that, when assembled together, form the as-needed computer generated model;
executing an as-needed script readable by a model viewing software application and related to the selected plurality of model sub-components,
wherein the as-needed script includes retrieval information for each of the plurality of model sub-components;
retrieving, based upon said as-needed script, a plurality of viewer-readable files corresponding to the selected plurality of model sub-components;
building the as-needed computer generated model from the plurality of retrieved viewer-readable files in a model viewing software application; and
displaying the as-needed computer generated model in the model viewing software application.

14. A system for building an as-needed computer generated model, comprising:
a multi-dimensional modeling tool for generating and storing a max-case model file relating to a max-case design model, wherein said max-case design model includes plurality of model sub-components;
a sub-component extraction utility electronically connected to said multidimensional modeling tool for extracting viewer-readable files for each of said plurality of model sub-components;
a viewer utility electronically connected to said sub-component extraction utility for generating a max-case design script that includes at least retrieval information for each of said plurality of model sub-components;
a product configurator application electronically connected to said viewer utility for receiving a user selection of particular as-needed model sub-components; and
a viewer application electronically connected to said product configurator application and said sub-component extraction utility for generating an as-needed design script including retrieval information for each of the as-needed model sub-components, retrieving, the viewer-readable files for each of the as-needed model sub-components, building the as-needed model from the retrieved viewer-readable files; and displaying the as-needed model to the user.

15. The system of claim 14 wherein said viewer utility extracts location information for each of the model sub-components.

16. The system of claim 14, wherein said sub-component extraction utility stores said viewer-readable files in at least one computer-readable medium.

17. The system of claim 14, wherein said product configurator application stores said user selection of particular as-needed model sub-components in at least one computer-readable medium.

18. The system of claim 14, wherein at least said multi-dimensional modeling tool, said sub-component extraction utility, said product configurator application, and said viewer application are located at remote locations to each other.

19. The system of claim 18, wherein the remote locations are connected by a computer network.

20. The system of claim 14, wherein said viewer-readable files are stored in a VRML file format.

21. The system of claim 14, wherein said viewer-readable files are stored in a TIFF file format.

22. The system of claim 14, wherein said max-case design script and said as-needed design script are stored in an ASCII file format.

23. The system of claim 14, wherein:
said sub-component extraction utility further extracts spatial orientation information related to the three dimensional orientation of each of the model sub-components;
said viewer utility further includes the spatial orientation information in the max-case design script;
said product configurator application further receives, from the user, sub-component placement and orientation information for each as-needed model sub-component; and
said viewer application further includes, within the as-needed design script, the received sub-component placement and orientation information.

24. The system of claim 23 wherein said spatial orientation information includes six degrees of freedom.

25. The system of claim 23, wherein said spatial orientation information includes coordinates for an angle of rotation about each of the x, y, and z axes, relative to a pre-established coordinate axes, and an offset in each of the x, y, and z directions relative to a predetermined model center point.

26. A system for building and displaying an as-needed computer generated model, comprising:
a product configurator application for receiving a selection of a plurality of model sub-components that, when assembled together, form the as-needed computer generated model;
a viewer application for executing an as-needed script related to the selected plurality of model sub-components,
wherein the as-needed script includes retrieval information for each of the plurality of model sub-components;
said viewer application further retrieving, based upon said as-needed script, a plurality of viewer-readable files corresponding to the selected plurality of model sub-components;
said viewer application further building the as-needed computer generated model from the plurality of retrieved viewer-readable files in a model viewing software application; and
said viewer application further displaying the as-needed computer generated model in the model viewing software application.
